(19) United States
(12) Patent Application Publication
(10) Pub. No.: US 2022/0318839 A1
(43) Pub. Date: Oct. 6, 2022

(54) SYSTEMS AND METHODS FOR APPLYING REWARD OPTIONS VIA NUDGES

(71) Applicant: SMILE INC., Kitchener (CA)

(72) Inventor: Eryn Alexa Dickison, Kitchener (CA)

(21) Appl. No.: 17/713,861

(22) Filed: Apr. 5, 2022

Related U.S. Application Data
(60) Provisional application No. 63/170,857, filed on Apr. 5, 2021.

(51) Int. Cl. G06Q 30/02; G06Q 30/06

(52) U.S. Cl. CPC G06Q 30/0233; G06Q 30/0635

(57) ABSTRACT

An example system includes an e-commerce platform to: identify a customer identifier associated with a customer browsing a vendor e-storefront on the e-commerce platform; and a loyalty rewards system in communication with the e-commerce platform, the loyalty rewards system to: receive the customer identifier; identify a point balance associated with the customer identifier; determine whether the point balance satisfies a threshold condition; when the point balance satisfies the threshold condition, select a reward option; and send, from a nudge module, a nudge including the selected reward option for presentation by the e-commerce platform to the customer; and wherein the e-commerce platform is further to: in response to an indication from the customer to apply the reward option, store the reward option for a subsequent purchase; and in response to a selection of one or more items for the subsequent purchase, apply the reward option to the selection.

### FIELD

The specification relates generally to e-commerce systems, and more particularly to e-commerce systems for applying reward options via nudges.

### BACKGROUND

E-commerce programs, commonly referred to as e-commerce platforms, allow users to shop at their merchant websites and there may be loyalty programs associated with the merchants. The users typically peruse the merchant websites, adding things to an online shopping cart typically until they are ready to “check-out,” in order to consummate their purchase. At that point, they are typically required to give personal information, along with financial information, to identify themselves to the e-commerce site in order to complete the purchase unless the user has a pre-existing account with all or some of the information needed for the purchase. Upon completing their purchases, the user typically may also receive a notification of the reward points awarded from the purchase as well as their total accumulated reward points with the merchant.

A goal of the loyalty reward programs of merchants is to retain their customers or shoppers through many repeat purchases. This may accomplished by the shoppers redeeming their reward points (from previous purchases) when purchasing an item. However, if the shoppers do not remember to redeem their rewards points, they may be less likely to be retained. Some systems may utilize nudges to prompt shoppers, however constantly sending nudges at inappropriate times causes strain on and excessive transmissions by the servers and may also result in customers being annoyed at the quantity of nudges.

### SUMMARY

According to an aspect of the present specification an example system includes: an e-commerce platform to: identify a customer identifier associated with a customer browsing a vendor e-storefront on the e-commerce platform; and a loyalty rewards system in communication with the e-commerce platform, the loyalty rewards system to: receive the customer identifier from the e-commerce platform; identify a point balance associated with the customer identifier for the customer; determine whether the point balance satisfies a threshold condition; when the point balance satisfies the threshold condition, select a reward option; and send, from a nudge module of the loyalty rewards system, a nudge including the selected reward option for presentation by the e-commerce platform to the customer; and wherein the e-commerce platform is further to: in response to an indication from the customer to apply the reward option, store the reward option for a subsequent purchase; and in response to a selection of one or more items for the subsequent purchase, apply the reward option to the selection.

According to another aspect of the present specification, an example method includes: identifying a customer identifier associated with a customer browsing a merchant e-storefront serviced by an e-commerce platform; identifying a point balance associated with the customer identifier; determining whether the point balance satisfies a threshold condition; when the point balance satisfies the threshold condition, selecting a reward option; sending a nudge including the selected reward option for presentation by the e-commerce platform to the customer; in response to an indication from the customer to apply the reward option, storing the reward option for a subsequent purchase; and in response to a selection of one or more items for the subsequent purchase, applying the reward option to the selection.

### BRIEF DESCRIPTION OF DRAWINGS

Implementations are described with reference to the following figures, in which:

FIG. 1 depicts a block diagram of an e-commerce system 100 according to an example embodiment of the present invention.

FIG. 2 depicts a flowchart implementing a part of a loyalty rewards system in accordance with an example embodiment.

FIG. 3 is a flowchart depicting a part of Match 215 in an example implementation of FIG. 2.

FIG. 4 is a schematic diagram of an example nudge in the system of FIG. 1.

FIG. 5 is a schematic diagram of an example checkout page in the system of FIG. 1.

FIG. 6 is a schematic diagram of another example nudge in the system of FIG. 1.

FIG. 7A is a flowchart of another example method of implementing a part of a loyalty reward system in accordance with an example embodiment.

FIG. 7B is a flowchart of an example method of Assist 715 in an example implementation of FIG. 7A.

FIG. 7C is a flowchart of an example method of Assist 715 in another example implementation of FIG. 7A.

FIGS. 8A and 8B are schematic diagrams of example pages including example nudges in the system of FIG. 1.

FIG. 9 is a schematic diagram of another example page including further example nudges in the system of FIG. 1.

FIG. 10 is a schematic diagram of another example page including further example nudges in the system of FIG. 1.

FIG. 11 is a schematic diagram of another example page including further example nudges in the system of FIG. 1.

FIG. 12 is a schematic diagram of another example page including further example nudges in the system of FIG. 1.

### DETAILED DESCRIPTION

Embodiments described herein provide enhanced computer- and network-based methods and systems for nudging users or shoppers to redeem reward points of a loyalty rewards program when purchasing items or services from merchant websites. The users may be guest users or registered users having accounts with the merchants. Reward points or reward options such as discount amounts (e.g., $10 off), discount percentages (e.g., 10% off), and the like. A loyalty rewards program may use reward points, rewards, and any combination thereof.

In completing an online purchase of a product or service online, some information about a guest user (“guest”) is provided to the merchant in order to complete the purchase. For example, the guest may provide the merchant with payment information, contact information, delivery addresses, and other identifiers. The guest may provide such information with each purchase order, or the guest may create an account with the merchant having the information already stored for purchasing from the merchant. A user may sign into their account with the merchant at any time. The user may also set up their computer to automatically sign into their account when they visit the merchant's website.

Further, it is a practice to request the guest's telephone number and/or email address in order to provide a text message (such as SMS—Short Message Service) or email where written confirmation of the purchase may be sent. Accordingly, guests or shoppers may be tracked when they provide the same or similar information to merchants for their subsequent transactions.

There are a number of methods to identify and/or track customers or users such as by telephone numbers and email addresses. Identifiers of a user comprise one or more of the following: name of a person or entity, telephone number, text messaging identifier, email address, payment information, physical address, delivery address, billing address, IP address, advertising ID, device ID, customer ID, social network ID, payment wallet, digital wallet, and such other contact information as may be used or developed.

E-commerce platforms, such as SHOPIFY, support merchants going online to sell their products and services. Some of the e-commerce platforms further provide tracking or matching of the registered users and guest users on merchant websites. For example, a customer identifier (customer ID), for example a number, is assigned to each new guest when a purchase is made at a merchant's website. The e-commerce platform would assign the same custom ID to the same guest, where detected as the same guest, for a subsequent transaction or purchase. For example, a transaction record (such as for a purchase) in the accounts of the merchant as provided by the e-commerce merchant may include customer ID, details of the purchase, date, and amount. Where the guest is matched to an existing guest, the previously assigned customer ID is used. The matching algorithms of the e-commerce platforms may include payment information, telephone number, and email address of the guest.

The customer ID from some e-commerce platforms may also be associated with other identifiers of the purchaser like the purchaser's name, telephone number and email address. For example, some customer IDs may only be associated with a name and telephone number. Other customer IDs may only have a name and email address. Some other customer IDs may only have just an email address. The number of possible combinations of associations with an example purchaser is very large and may further change over time. For example a purchaser may change their telephone number, physical address, or email address. A purchaser's identifiers may have more than one telephone number, email address, etc. A purchaser's identifiers may also be transferred to other purchasers for various reasons such as a telephone number being transferred to another purchaser.

The identifiers which may identify (or associate with) a guest user may be highly complex. It is thus advantageous to use a guest matching service, which may provide customer IDs, as provided by some e-commerce platforms along with some example identifiers like telephone numbers and email addresses which can further be used to authenticate the guest or guests.

Once a guest user is identified by various means including the techniques noted in this document, technical means may also be used to continuously track when the guest user visits a merchant website using the same computing device. For example, cookies (as is commonly known) or information packets may be used where the guest user may be identified when visiting a merchant's website. Similarly, a user with a registered account may be automatically signed into the account when visiting a merchant's website using known methods.

Once a user is identified whether from signing into their account or as a guest user, nudges may be presented to the user while the user is shopping anywhere on a website including viewing the cart, home page, and product pages. Further, the user may also be presented with action items such as click to use points, select what you to redeem for in a panel, apply reward to items in a cart, apply code, and click to view reward.

In addition to purchases of products or services, reward points may also be earned for other activities such as referring another user to a merchant, providing a review on a social network for the merchant, and creating an account with the merchant.

Once a guest user has earned reward points with a merchant, the guest user may redeem their reward points by creating an account with the merchant to become a registered user and redeeming their reward points using the process for redeeming reward points of registered users. The guest user may be linked to their registered user account through the same identifiers such as the same email address.

However, some guests may wish to redeem their reward points without becoming registered users. Guests may redeem their reward points through a Uniform Resource Locator (URL), commonly known as a link. An example link may be http://www.server.com/main/2557njfogugweg. The guest user may use the link to initialize the process to redeem the reward points. The process may include authenticating the guest user at some point.

The present invention relates to an e-commerce system which can better prompt users to redeem points. The system identifies users by their customer identifier and determines whether they have enough points in their point balance to redeem points. If their point balance satisfies a threshold condition, the system provides a nudge including an option to redeem the reward. If the user redeems the reward, the system stores the redemption for application to the user's next purchase. This reduces the number of interactions between the user and the server since it streamlines the process, since the reward option is precomputed by the system, and this precomputed reward option is presented and can be immediately applied. Thus the user does not need to make a request to view possible reward options, for example by navigating to an account page or the like, and does not have to make a request to apply the reward once the user reaches a checkout process.

As used herein, the term “merchant” is intended to be broadly construed to mean any type of seller, dealer, retailer, distributor, or store owner or operator, including a non-profit organization. The term “product” is intended to be broadly construed to mean any type of goods and/or services. The term “application” is intended to be broadly construed to mean any type of software product, whether delivered by download, storage device, or otherwise, whether an integrally provided component of the ecommerce platform or separately provided for integration and use therewith, and/or whether stored remotely and accessed over a communications network or stored locally. The term “loyalty rewards system” or “loyalty rewards platform” is intended to be broadly construed to mean an application providing the essential functionality, but not necessarily all of the functionally, described and claimed herein. The term “ecommerce platform” is intended to be broadly construed to mean any type of software technology solution that (a) provides merchant-facing backends that enable merchants to customize and manage customer-facing storefronts on their websites for selling their products to their customers and (b) has an API or other interface for working with the recurrence application as described herein (as such, the terms “application” and “platform” are used interchangeably herein with respect to the ecommerce software, and any distinction between these terms is not considered important to a full understanding of the invention).

As used herein, the terms “customer” and “user” are intended to be interchangeably herein and are to be intended broadly construed to mean the customers of the merchants. As used herein, the term “reward points” or “rewards points” are intended to be construed to mean points of a loyalty reward program, but may also be intended to mean currency (such as $5.00 dollars) as some loyalty reward programs may issue currency amounts instead of points or in combination with points.

It will be appreciated that although example embodiments are shown and described in conjunction with the SHOPIFY platform, the loyalty rewards system application can be implemented for use with other ecommerce platforms.

It will be appreciated that although example embodiments are shown and described in conjunction with the SHOPIFY platform, the loyalty rewards system application can be implemented for use with other ecommerce platforms and may also be used with servers or computers of merchants directly where the ecommerce platform functions are handled by the servers or computers of merchants. The functions of the loyalty rewards system, the merchant computer, and the ecommerce platforms are implemented in software and, as such, this software may be executed on any number of different computers, servers, and platforms without leaving the scope of this invention.

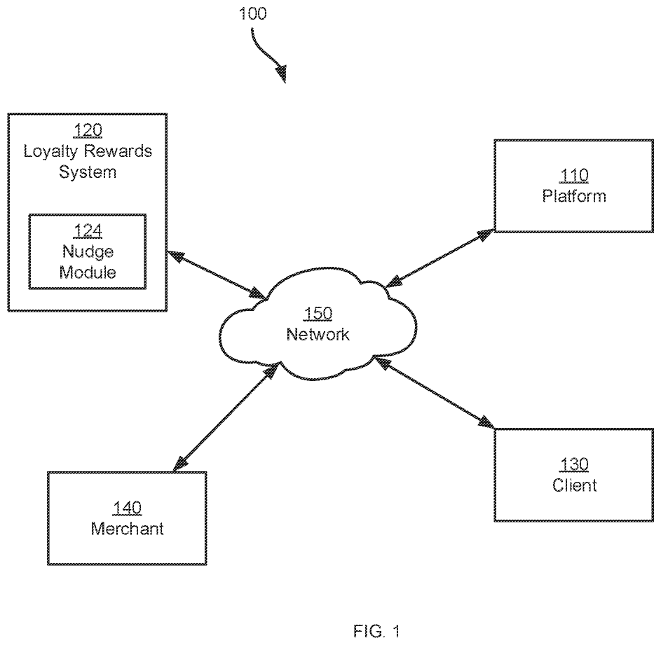

FIG. 1, there is shown a block diagram depicting an Ecommerce System 100 according to an example embodiment of the invention. The Ecommerce System 100 includes a Platform 110 that has an ecommerce platform application that communicates with a Loyalty Rewards System 120, a Client 130, and a Merchant 140. The Platform 110 can communicate with the Loyalty Rewards System 120, the Client 130, and the Merchant 140 via any suitable connection such as the Internet or another communications network 150. While certain embodiments are described in which parts of the Ecommerce System 100 are implemented in software, it will be appreciated that one or more acts or functions of the loyalty award system may be performed by hardware, software, or a combination thereof, as may be embodied in one or more computing systems. For example, the Loyalty Rewards System 120, the Platform 110, the Client 130, and the Merchant 140 can be embodied as stand alone application programs or as a companion program to a web browser having messaging and storage capabilities.

Further, although one Client 130 and one Merchant 140 are shown for ease of illustration, it should be appreciated that there may be any number of merchants and/or clients who can be served by the Platform 110 in the manner described herein.

Similarly, although one Platform 110 is shown for ease of illustration, it should be appreciated that any number of them can be included in the Ecommerce System 100, for example in cloud-based and/or server-farm systems, or where the ecommerce platform and the application are located on separate but still connected/accessible servers (for example the recurrence application can call the ecommerce platform's API using the HTTP protocol).

The Loyalty Rewards System 120, the Platform 110, the Client 130, the Merchant 140 and/or other data processing resources as may be required, can communicate over the network 150. For example, the network 150 can include a telecommunications network, a local area network (LAN), a wide area network (WAN), an intranet, an Internet, or any combination thereof. In an exemplary embodiment, the communication between the Loyalty Rewards System 120, the Platform 110, the Client 130, and the Merchant 140 can be encrypted to protect and secure the data communication between the systems. It will be appreciated that the network connections disclosed are exemplary and other means of establishing a communications link between the Loyalty Rewards System 120, the Platform 110, the Client 130, and the Merchant 140 can be used.

The Loyalty Reward System 120, the Platform 110, the Client 130, and the Merchant 140 are communications to provide the services to the user on the Client 130. In providing the services to the user, the Loyalty Reward System 120 is able to track what the user is doing at the Merchant 140, the merchant's website. The tracking includes receiving information on what items are in the user's shopping cart at any one time, and what page is the user accessing at the merchant's website at any given time such as whether the user is viewing the details of an item. This tracking may be carried out using known methods.

The Platform 110 can include, for example, applications including computer-readable instructions for allowing the Platform 110 to perform the functionality described herein, which may be used for or by the merchant. The applications may be stored in a non-transitory machine-readable storage medium, such as a memory of the Platform 110. Such applications can provide for receiving, processing, and reconciling orders, billing, and inventory functions, and presenting such information to the Merchant 140. For example, such applications can include the ecommerce platform for hosting an e-commerce storefront (e-storefront) for the Merchant 140 and making the e-storefront interface accessible to the Client 130. And such applications can include an interface to the Merchant 140 to customize rule sets for offering products for sale to the users (e.g. users accessing e-storefront from Clients 130), and accepting orders for such products.

The Platform 110 further provides functionality to assist the merchants in managing their e-storefront. The merchants are able to track their users', whether registered or not (i.e. guests), activities relating to their e-storefronts. For example, Platform 110 generates an event of each purchase order of a user from a merchant's e-storefront. The event is associated with the merchant and the user and is accessible by both parties for their records. A record of the event can include customer ID (of the user), guest or registered (whether the user has created an account with the merchant), telephone number (of the user), email address (of the user), product purchased, date of purchase, and payment amount. This short list of information relating to a record is for illustration only. Such records may typically contain more or less information.

In some platforms, the telephone number or email address (or any other identifiers) of the user may be used as the customer ID by the platform to identify the user. The Platform 110 may assign a new customer ID to an event if it is not able to match the user to an existing user. If it is able to match the user to an existing user, the Platform 110 will provide the customer ID of the user to their purchase order. A registered user will have already created an account (store account) with the merchant and if the purchase is made under their account then the record of the event will have their assigned customer ID. Where a guest user (who does not have an account) makes a purchase, the record of the event will have the customer ID either as newly assigned where there is no match to an existing guest user, or an existing customer ID where a match is detected based on the profile of an existing guest user (for example, the same email address is used by the guest user).

The Merchant 140 is, for example, a computer from which a merchant can access and run their business through their e-storefront on the Platform 110. The Client 130 is, for example, a computer from which a user (who may be a shopper or customer) can access and interact with the e-storefront of various merchants to, for example, purchase their products.

The Loyalty Rewards System 120 implements a loyalty reward program for merchants through their e-storefronts. The Loyalty Rewards System 120 is configured to create, collect, manage, and modify information associated with user loyalty rewards accounts. Information associated with a loyalty rewards account can include, for example, user identification information, user contact information, user purchase information, historical user information, a loyalty award amount (the reward points), and other information necessary for implementing the Loyalty Rewards System 120.

The Loyalty Reward System 120 further comprises a nudge module 124 configured to interact with users including presenting information to users and receiving instructions from users, such as text input by users in a field, clicking of buttons, selection of boxes and the like.

The Loyalty Rewards System 120 is further extendable to the web pages of the e-storefront in the form of an embedded application within the web pages. The embedded application provides a user interface for interacting with users and displaying data relevant to a user's loyalty rewards account. The interactions with the users further include presenting nudges to the user while the user is shopping anywhere on a website including viewing the cart, home page, and product pages. Further, the user may also be presented with action items such as click to use points, select what to redeem for in a panel, apply rewards to items in a cart, apply code, and click to view rewards.

The records of events are processed by the Loyalty Rewards System 120 and reward points are awarded for each of the events which are then added to the loyalty rewards accounts of the users. The loyalty rewards accounts are identified by their respective customer IDs for both guest users and registered users.

In some examples, the Loyalty Rewards System 120 may be implemented on a server or suite of servers separate from the Platform 110, while in other examples, the Loyalty Rewards System 120 may be integrated with and implemented by the Platform 110. The functionality described herein may be performed by the loyalty rewards system 120 in cooperation with the platform 110 (e.g., by communicating instructions and data therebetween) and/or directly by the loyalty rewards system 120 when the loyalty rewards system 120 is, for example, integrated with and implemented by the platform 110.

The Platform 110 can also include sending a text message using a messaging service to confirm the events, e.g., purchase order, to the user's messaging address. The message address may be a telephone number for text messages, an email address for text messages, and any other messaging service. Messages on the reward points earned by the users may similarly be sent to the users whether they are guest users or registered users.

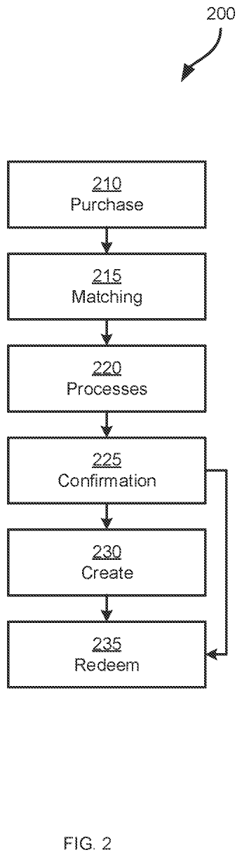

FIG. 2 is a flow chart depicting a Method 200 of implementing a part of the Loyalty Rewards System 120 in accordance with an example embodiment. The method 200 may be implemented in part or in whole by the Loyalty Rewards System 120, the Platform 110, or a combination of the two, or other suitable computing devices and/or systems. An example entry point into the Method 200 for a guest user starts with identifying the user (with for example a customer ID), for example by the Platform 110. Once identified (or signed in), the Loyalty Rewards System 120, through the nudge module 124, interacts with the user to further present nudges to the user while the user is shopping anywhere on a website including viewing the cart, home page, and product pages. Further, the Nudge module 124 may also present users with action items such as click to use reward points, select what you to redeem for in a panel, click to apply reward to items in a cart, click to apply code, and click to view reward. The terms “click” and “select” are user actions and are used for clarity. They are not intended to limit the types of user interactions available with the Nudge module 124. The Nudge module 124 may use any of the types of user interactions known in the art.

The user starts with a Purchase 210 of a product(s) from a Website of a Merchant Store (e.g., from an e-storefront serviced by the Platform 110). From the Client 130, the user selects the product(s) to purchase. The selected product(s) or item(s) to purchase may be added to what is commonly known as a shopping cart.

The Purchase 210, once submitted for checkout (a commonly known process), is received by the Platform 110 for Matching 215 to verify the customer ID (verification is optional), to obtain payment information and other information as is needed (for example, an email address), and to apply any discount or promotional codes. The Platform 110 fully Processes 220 the purchase once the user clicks to purchase or finally confirms such. A record of the event, this purchase, is updated for the merchant's account on the Platform 110. The step of verifying the customer ID is optional and may be skipped if the customer ID verification has sufficient accuracy such as when the user has signed into their account with the merchant in their purchase or such as when the customer ID is provided by the Platform 110 based on the user's provided information (such as the email address). The Processes 220 further includes providing this purchase event to the Loyalty Reward System 120 so that reward points or rewards can be awarded to the user's account or the customer ID if the user is a guest user. The customer ID is effectively a loyalty award account in this example.

The customer ID may be verified to actually belong to the registered user or guest user by a number of known methods such as confirmation from an email sent to the user's email address.

A Confirmation 225 of the purchase is also sent to the user so that they may have a written confirmation of their purchase. Further, the Confirmation 225 includes a URL link as an invitation to the guest users to Create 230 a store account with the merchant so that the user (where it is a guest user) may become a registered user and be able to access their loyalty award account and to Redeem 235 their rewards accordingly. An example redemption of reward points is redeeming 100 reward points for a $10 discount code which the user can enter on their next purchase from the merchant for the discount.

Alternatively, the URL link of Confirmation 225 sent via email, or an unsecured messaging service, can initially point to Redeem 235 for redemption within a limited time period (for example one hour) and after the time period, the URL link can then point to Create 230.

Further alternatively, the URL link of Confirmation 225 sent via email, or an unsecured messaging service, can point to a web page indicating that a new URL link has been sent to the user's email address with Redeem 235 for redemption within a limited period (for example one hour). After the time period, this new URL link may be directed to the same web page indicating that another URL link has been sent to the user email address with Redeem 235 for redemption within a limited period (for example one hour). This cycle of emails and URL links may be repeated as authentication for users to access their loyalty award accounts to view and/or redeem their reward points. Other authentication methods may also be used, such Verification codes instead of URL links.

Where the Confirmation 225 has been sent to a guest user via a secured communications means such as via SMS to their telephone number, a URL link to Redeem 235 is included in the confirmation so that a guest user may accordingly redeem their reward points without becoming a registered user.

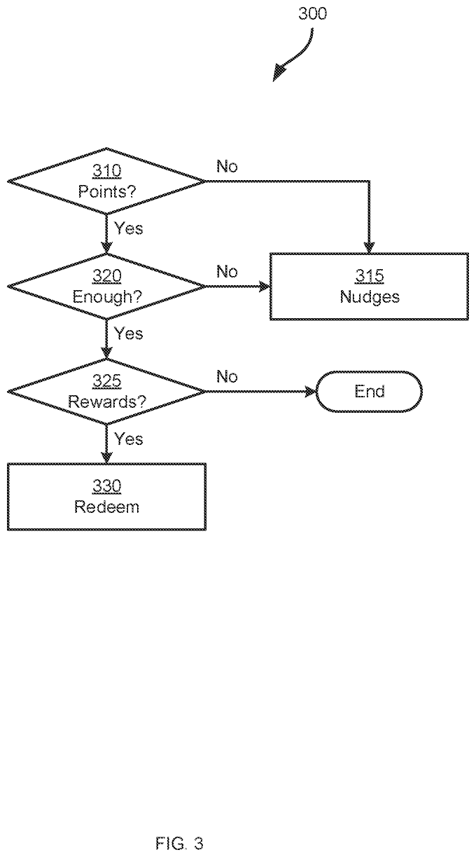

FIG. 3 is a flow chart depicting a part of Match 215 in an example implementation of FIG. 2. Similar to the method in FIG. 2, the example entry point into the method 300 is the identification of a user. That is, the Platform 110 identifies a customer identifier (e.g., based on email address etc. for a guest user or account information for a registered user) associated with the user or customer browsing the e-storefront of the Merchant 140 serviced by the Platform 110. The Platform 110 may then send the customer identifier to the Loyalty Reward System 120. Preferably, the Platform 110 may send the customer identifier to the Loyalty Reward System 120 based on the identification of the customer, however in other examples, the Platform 110 may further detect a predictor of a purchase by the customer and send the customer identifier. For example, the predictor may be viewing or accessing a specific product page, clicking on or accessing on product details (e.g., selecting a size or color or other attribute for purchase, or viewing product information such as material/composition, care and/or use details, etc.), selecting an item for purchase (i.e., adding an item to the shopping cart), or the like.

The Loyalty Reward System 120 receives the customer identifier from the e-commerce platform and identifies a point balance associated with the customer identifier. In particular, the Loyalty Reward System 120 determines whether the point balance for the user satisfies a threshold condition. For example, the threshold condition may be a threshold point balance. If the Loyalty Reward System 120 determines that the user has reward Points 310 satisfying the threshold condition (e.g., a point balance exceeding the threshold point balance), then the method 300 proceeds to Enough 320.

If the Loyalty Reward System 120 determines that the user does not have enough reward Points 310, then the method 300 proceeds to generate Nudges 315. In particular, the Nudge module 124 of the Loyalty Reward System 120 generates encouragement Nudges 315 for presentation to the customer or user to encourage the user to earn reward points (or reward discounts or reward amounts of money) to the user. Example encouragement nudge messages include “Earn 100 reward points for every $10 purchase” (example encouragement) and “Click ‘Allow’ and get $3 off your 1st order” (example amount reward as well as being an interaction).

If the user has reward Points 310 (YES) to satisfy the threshold condition, then the Loyalty Reward System 120 determines whether or not the user has Enough 320 reward points, or already has a reward like a “$3 off your 1st order”. If the user does not have Enough 320 rewards points, then Nudges 315 would be presented and may include further example messages like “Only need to purchase $37 to earn 10% discount” and “Only need another 25 reward points to qualify for a $10 discount”. If the user does have Enough 320 rewards points, then the loyalty rewards system 120 determines the Rewards 325. That is, the Loyalty Rewards System 120 selects a reward option (Rewards 325). The reward option may be, for example, a discount percentage, a discount amount, or the like. The reward option selected based on the largest available reward option, a smallest available reward option, a randomly-selected available reward option, or other criteria. The available reward options may be based on possible redemption options based on the point balance associated with the customer identifier.

The nudge module 124 may then send a nudge (Rewards 325) including the selected reward option for presentation to the customer. For example, the Rewards 325 nudges may include messages such as “Congratulations! You have $5 off your next purchase” with a “Use Now” button to Redeem 330.

The e-commerce Platform 110 and/or the Loyalty Reward System 120 may then receive a response to the Rewards 325 nudge from the customer or user. If the response indicates that the customer does not wish to apply the reward option (e.g., by closing the nudge or not receiving a response), then the method 300 ends.

If the response includes an indication from the customer to apply the reward option (e.g., the customer clicks the “Use Now” button), then the method 300 proceeds to Redeem 330. The e-commerce Platform 110 may then store the reward option for a subsequent purchase. In response to selection of one or more items for the subsequent purchase, the reward option is applied to the selection.

For example, the e-commerce Platform 110 may determine whether a cart of a current session includes one or more selected items. When the cart includes one or more selected items, the Platform 110 may apply the reward option to the cart (i.e., the current purchase). When there are no items in the cart, the reward option would be applied to the next items in the cart which could be during the same session or a later session when the user returns to the merchant website after, for example, a few days. In some examples, the reward option may be stored by the Platform 110, while in other examples, the reward option may be sent back to the Loyalty Rewards System 120 to store, for example, if the current session ends without the customer making a purchase to which to apply the reward option. An example of applying the $5 off to the purchase is the Loyalty Rewards System 120 entering the discount code for the $5 off for the user.

After the reward option is redeemed at 330, the Loyalty Reward System 120 updates the point balance associated with the customer identifier.

The nudges of Nudges 315 and Rewards 325 may be presented at any of the pages of the merchant's website including the home page and the checkout pages. Further, the nudges of Nudges 315 and Rewards 325 may be presented at the same time at any of the pages of the merchant's website. For clarity, more than one nudge may be presented on one page of a merchant's website at any one time.

Advantageously, the nudges containing Rewards 325 allow the user to be presented with appropriate usage of points at an appropriate time and streamline the communications between the Loyalty Reward System 120 and the Platform 110 by precomputing a reward option if the customer has a sufficient point balance and storing the reward option at the Platform 110 for application to the next purchase. That is, additional steps of viewing the point balance, selecting, by the user, a reward option, and transmitting that back and forth to Platform 110 both at the selection phase, as well as the redemption phase (i.e., during checkout) may be eliminated, thereby reducing the data transmission requirements between the Loyalty Rewards System 120 and the Platform 110.

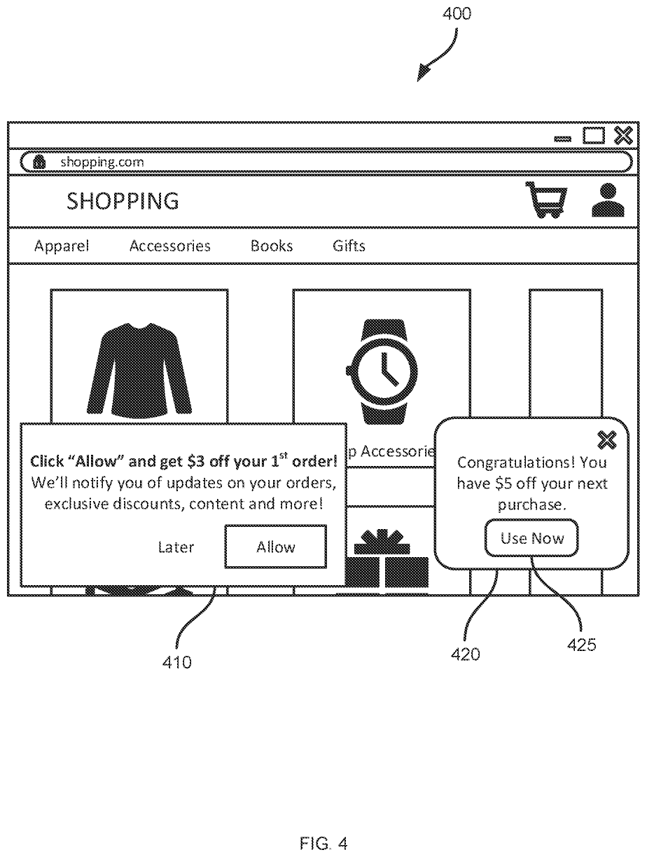

FIG. 4 is a display 400 showing example nudges during execution of the method 300. From one merchant's website page, an example of a Nudge 420 (also an example of Reward 325 nudge) with a user interaction where there is a rewards type message of “Congratulations! You have $5 off your next purchase” with a user interaction 425 “Use Now” button if a user wishes to redeem their reward. There is also Another Nudge 410 (also an example of Nudge 315 of how to earn rewards or reward points) having a message “Click ‘Allow’ and get $3 off your 1st order! We'll notify you of updates on your orders exclusive discounts, content, and more” and two user interaction buttons: Allow and Later.

The redemption Nudge 420 is, for example, on the landing or home page of the merchant. By showing the reward option that can be redeemed instead of reward points, user friction in the process of redemption can be reduced. Additionally, by displaying the nudge earlier in the process, that is, upon identifying the customer, rather than at checkout, the communications between the Loyalty Reward System 120 and the Platform 110 may be streamlined to identify and apply the rewards. This may create a user experience where users feel like they are being offered a reward at an appropriate time and makes spending their points easier, reducing the load of needing to remember about your points.

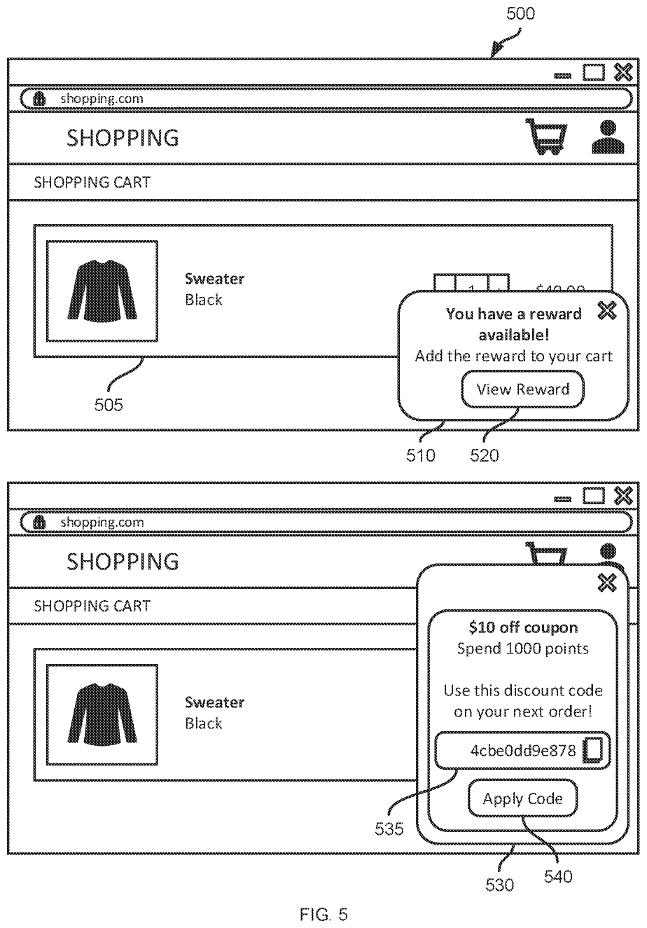

FIG. 5 is a display of an example checkout page with nudges. There is shown a checkout page 500 with a shopping cart showing a Sweater 505 in the cart, a nudge 510 asking if a user wishes to view their earned reward “You have a reward available”, “Add the reward to your cart” by clicking a “view reward” button 520. The checkout page 500 is additionally shown with the Rewards 530 nudge where the “view reward” button has been clicked by the user. The Rewards 530 nudge shows a message “$10 off coupon”, “Spent 1,000 points”, “Use this discount code on your next order!”, the discount code 535 (“4cbe0dd9e878”), and a “Apply code” button 540. The user clicks the “Apply code” button 540 to use 1,000 earned reward points to apply a $10 coupon to the current order in the shopping cart. If this order in the shopping cart is not complete then the discount code “4cbe0dd9e878” may then be used for their next order to apply the $10 coupon. This discount code “4cbe0dd9e878” continues to be listed as earned reward in the user's account until it is used and may be shown, for example, in Nudge 420 on the user's next visit to the merchant website if this order is not completed.

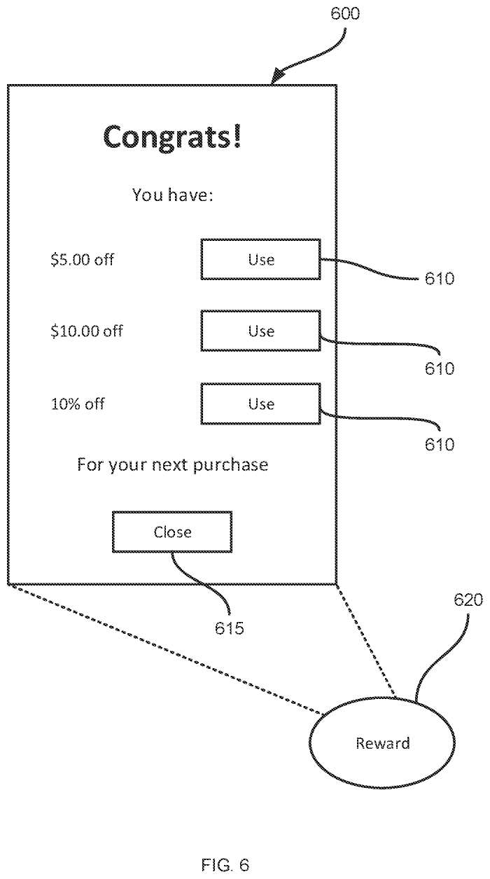

FIG. 6 is a display of another example Nudge of FIG. 4. In another example of Nudge 600, there is shown a nudge with three (3) rewards in which one or any combination of the rewards or reward options may be selected to be used. That is, at Rewards 325, rather than automatically selecting, by the Loyalty Reward System 120, a plurality of the available reward options may be presented in Nudge 600 to the user and the selection of a designated reward option to be applied.

This Nudge 600 is a user interaction nudge where there is a rewards type message of “Congrats! You have ‘$5 off’ ‘$10 off’ ‘10% off’ For Your Next Purchase” with a user interaction 610 “USE” button beside each reward ‘$5 off’, ‘$10 off’, or ‘10% off’. A user may click one or more of the user interaction 610 “USE” buttons to select the reward beside each of the buttons. An interaction by the user using any option 610 may be interpreted by the e-commerce platform 110 as the indication to apply the reward option, and hence the e-commerce platform 110 may then apply the designated reward option.

Further, there is a Button 615 to either close the Nudge 600 window or to reduce the size of Nudge 600 to Reduced 620 so that the user may continue shopping with minimal interference from Nudge 600.

In an alternative implementation, Nudge 600 (or Reduced 620) is either persistent on all the pages of the merchant website or accessible from these pages. The Reduced 620 becomes Nudge 600 when the icon is clicked. The rewards selected on Nudge 600 may be changed before the associated purchase is submitted for completion. In particular, at the checkout pages of the Nudge 600 (such as the checkout page or shopping cart page shown in FIG. 5), the Sweater $40 shown in FIG. 5 could be shown, for example: as Sweater costing $30 if the ‘$10 off’ is selected for redemption, or as Sweater costing $26 if the ‘$10 off’ and ‘10% off” are selected for redemption. While a single item is used in this example, many items may be in the shopping cart for checkout and the total cost of the items may be adjusted by the user by selecting or deselecting the rewards for redemption. The users are thus able to optimize their redemption of reward points in order to maximize the value received from their reward points over this and other subsequent purchases. For example, a user may not wish to use the ‘10% off’ discount for the Sweater 505 purchase, but may have plans to make a subsequent purchase of greater cost.

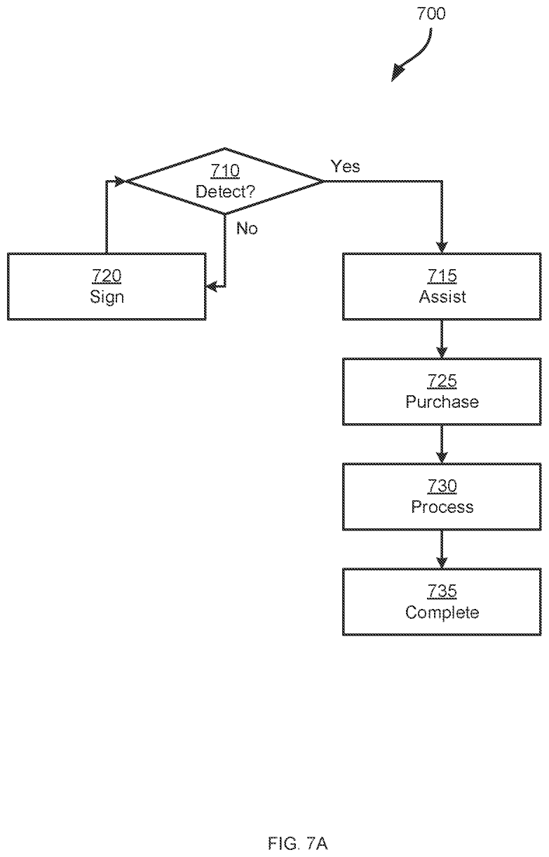

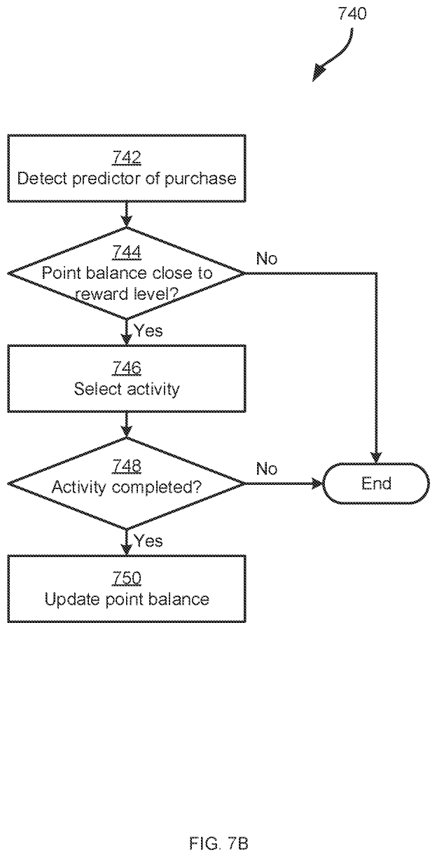

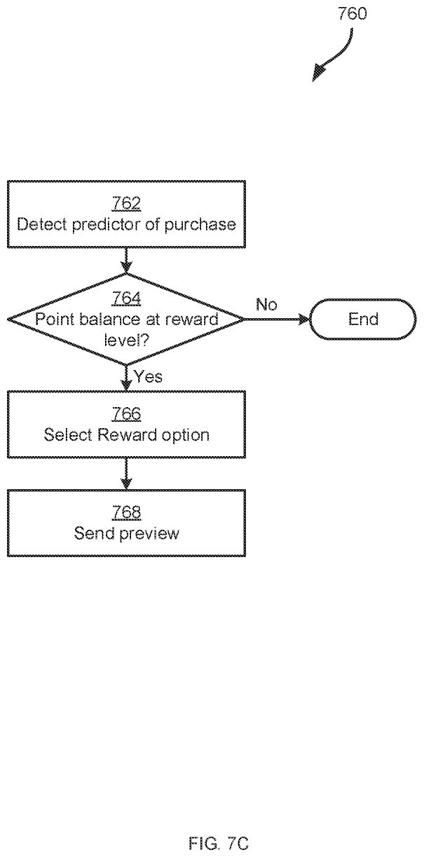

FIG. 7A is a flow chart depicting a Method 700 of implementing a part of the Loyalty Reward System 120 in accordance with another example embodiment. In an example entry point into the Loyalty Reward System 120, a user browses to a merchant's website. The Loyalty Reward System 120 and/or the Platform 110 initiates a Detection 710 to determine if the user can be identified based on, for example, the user's browser automatically signing into the user's account at the merchant's website, or another means of identifying the user, as is known, such as by a cookie on the user's browser. If YES, the user is be identified or verified, then the Nudge module 124 of the Loyalty Reward System 120 provides Assist 715 nudges to improve the user's buying experience on the merchant's website or e-storefront such as during Purchase 725, Process 730, and Confirmation 735 before the user's purchases are Completed. The nudges of Assist 715 improve user buying experience by, for example, the rewards available to be used, the purchases needed to earn the next reward, how to earn rewards or reward points, the cost the item or items in the cart or in the focus of the user, and other such means to provide ease of use for the user.

For example, referring to FIG. 7B, an example method 740 of generating nudges at Assist 715 is depicted.

At block 742, the platform 110 and/or the loyalty rewards system 120 detects a predictor of a purchase by a customer on an e-storefront serviced by the platform 110. For example, the predictor may include accessing a product page, accessing product details (e.g., information, selecting product attributes, etc.), selecting a product for purchase (i.e., adding a product to the cart), and the like. In particular, by generating nudges at 715 in response to a predictor of a purchase by a customer, the loyalty rewards system 120 may optimize nudges which may actually trigger a response by the customer, rather than sending continuous streams of nudges which may be ignored by the customer. The loyalty rewards system 120 may therefore reduce the number of transmissions by the nudge module 124 which are routed through the e-commerce platform 110 and presented to the customer.

At block 744, in response to detection of the predictor of a purchase at block 742, the loyalty rewards system 120 determines whether a point balance associated with the customer identifier detected at 710 is within a threshold distance of a rewards level. For example, the rewards level may be a predefined point balance. The loyalty rewards system 120 may define a plurality of rewards level, each corresponding to a predefined point balance, and redeemable for a different reward option (e.g., varying based on the type of reward option, such as free gifts, discounts, etc., or varying based on the amount or value of the reward option). The threshold distance may be a number of points or a percentage of points defining the rewards level.

If the loyalty rewards system 120 determines at block 744 that the point balance is within the threshold distance of a rewards level, then the method 700 proceeds to block 746. At block 746, the loyalty rewards system 120 selects an activity associated with a designated number of points for presentation to the customer. In particular, the activity may be an interaction such as a subscription (e.g., to sign up for newsletters, etc.), a game, a social media action (e.g., to share the website with friends or to follow the merchant on social media), or a passive action such as viewing an advertisement or the like.

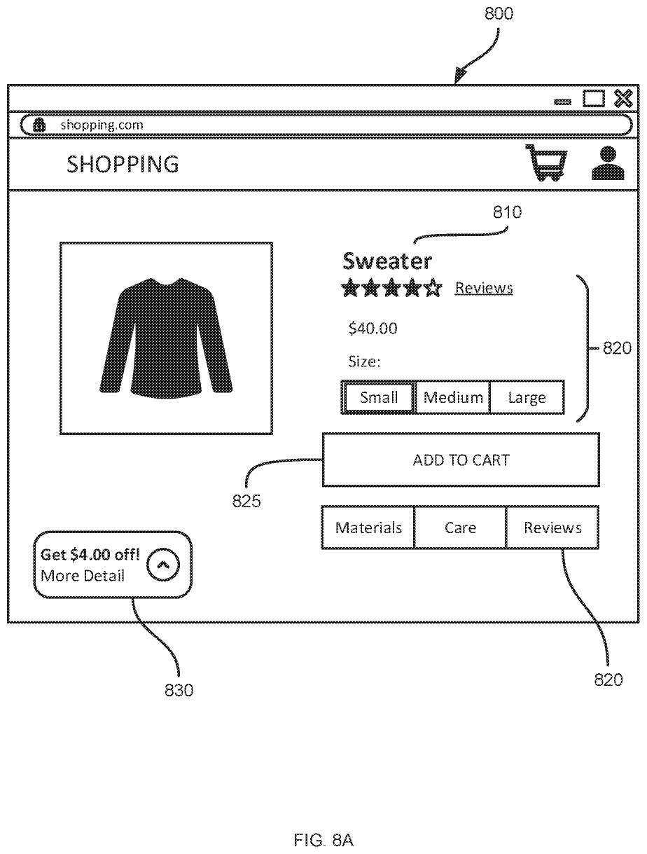

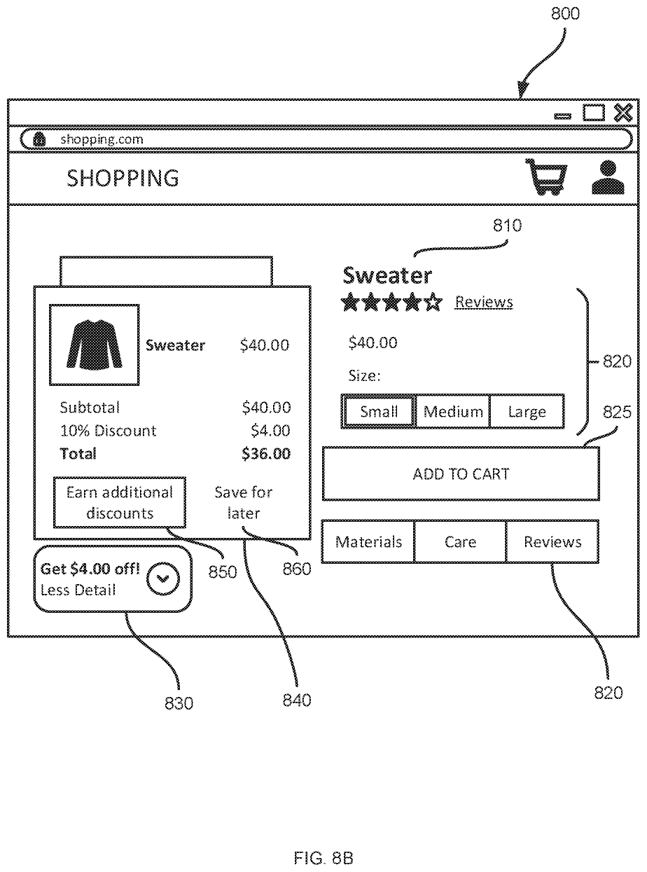

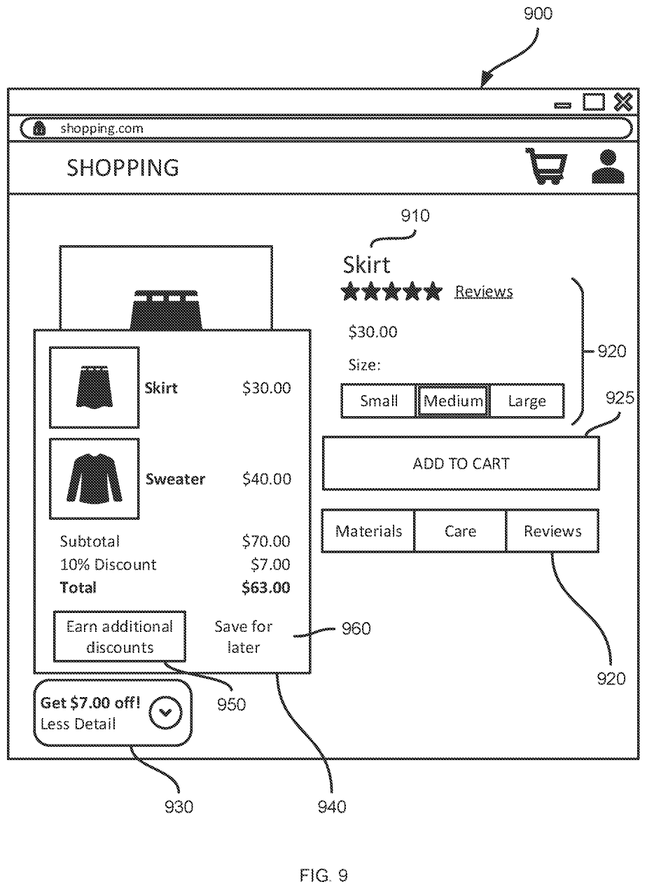

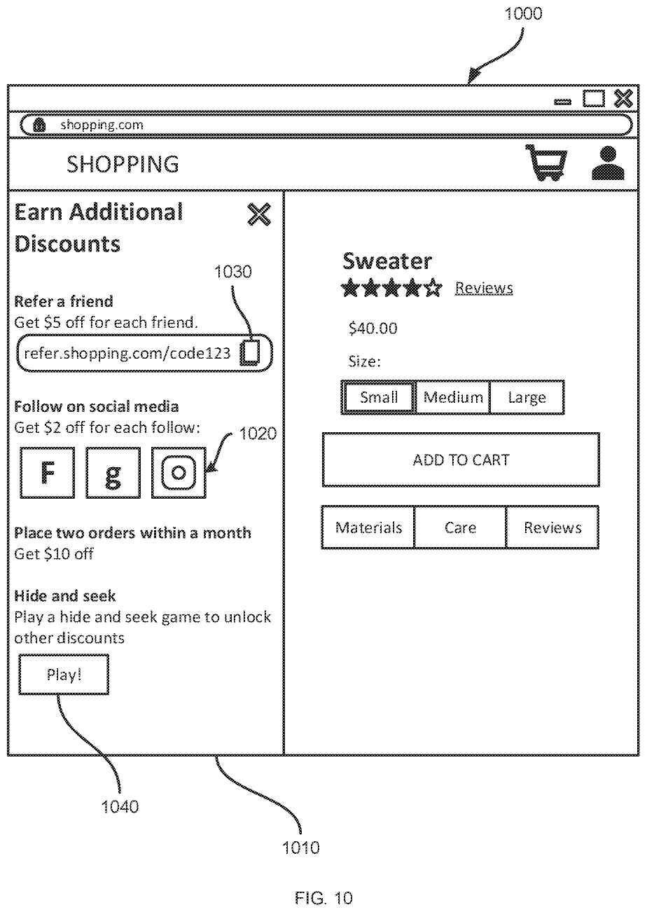

Preferably, the nudge module 124 of the loyalty rewards system 120 may incorporate the activity as a nudge and send the nudge for presentation to the customer. In some examples, in addition to the selected activity, the nudge may include an indication of the distance to the next rewards level. For example, the nudge may indicate an amount of money to be spent to reach the next reward level, a number of points to reach the next reward level, or the like. The nudge may be a small icon such as nudge 620, or nudges 830 or 930 illustrated in FIGS. 8 and 9, respectively. The nudge may include text indicating the distance to the next reward level. For example, the text could be “Spend $100 for $10 off”, “Earn 20 more points for $10 off”, “You have 128 points—another 30 points for $10 off”, or “You have spent $350—spend another $50 for $10 off”. The nudge may include detail information which may be displayed upon expansion. For example the detail information may include the activity, or additional options for how to earn rewards or reward points, as illustrated in Nudge 1010 in FIG. 10.

Each activity may be associated with a different designated number of points, and hence the loyalty rewards system 120 may select the activity such that the associated designated number of points exceeds the difference between the customer's point balance and the rewards level. As will be appreciated, in some examples, blocks 744 and 746 may be performed dynamically and/or in tandem to optimize activity selection and presentation of the activity so that the customer is likely to be motivated to complete the activity, thereby reducing the number of transmissions from the loyalty rewards system 120.

In some examples, the loyalty rewards system 120 may select more than one activity for the customer to potentially interact with. The activities may be selected to each have an associated designated number of points which is greater than the difference between the customer's point balance and the rewards level, or such that the sum of the associated designated number of points is greater than the difference to allow the customer to complete multiple activities to achieve the rewards level. In such examples, multiple activities may be incorporated into the nudge transmitted by the nudge module 124, wherein the multiple activity options are to be presented upon expansion of the nudge.

At block 748, the loyalty rewards system 120 determines whether the activity was completed by the customer. For example, the loyalty rewards system 120 may cooperate with the e-commerce platform 110 to determine the completion of the activity. If the activity is completed at block 748, the method 700 proceeds to block 750.

At block 750, the loyalty rewards system 120 updates the point balance based on the designated number of points for the completed activity. That is, the loyalty rewards system 120 adds the designated number of points to the point balance associated with the customer identifier.

If, at block 744 the point balance is not within the threshold distance of a reward level, or at block 748, the activity is not completed, the method 700 may end. Thus, nudges and data transmissions pertaining to potential activities may be reduced in situations where the customer is unlikely to complete the activities (i.e., when the current point balance is too far away from a reward level). Additionally, completion of the activity may time out after a designated amount of time, for example, to improve customer experience.

Referring to FIG. 7C, another example method 760 of generating nudges at Assist 715 is depicted.

At block 762, the platform 110 and/or the loyalty rewards system 120 detects a predictor of a purchase of an item by a customer on an e-storefront serviced by the e-commerce platform 110. For example, the predictor may include accessing a product page, accessing product details (e.g., information, selecting product attributes, etc.), selecting a product for purchase (i.e., adding a product to the cart), and the like. In particular, by generating nudges at 715 in response to a predictor of a purchase by a customer, the loyalty rewards system 120 may optimize nudges which may actually trigger a response by the customer, rather than sending continuous streams of nudges which may be ignored by the customer. The loyalty rewards system 120 may therefore reduce the number of transmissions by the nudge module 124 which are routed through the e-commerce platform 110 and presented to the customer.

At block 764, in response to detection of the predictor of a purchase at block 762, the loyalty rewards system 120 determines whether the point balance associated with the customer identifier satisfies a threshold condition. For example, the threshold condition may be a threshold point balance. If the loyalty rewards system 120 determines at block 764 that the point balance does not satisfy the threshold condition, the method 760 may end. If the loyalty rewards system 120 determines at block 764 that the point balance does satisfy the threshold condition, the method 760 proceeds to block 766.

At block 766, the loyalty rewards system 120 selects a reward option. The reward option may be, for example, a discount percentage, a discount amount, or the like. The reward option selected based on the largest available reward option, a smallest available reward option, a randomly-selected available reward option, or other criteria. The available reward options may be based on possible redemption options based on the point balance associated with the customer identifier.

At block 768, the loyalty rewards system 120 sends a reward preview to the e-commerce platform 110 for presentation to the customer. In particular, the preview includes the reward option selected at block 766 and a discounted price for the item computed based on the selected reward option.

Preferably, the nudge module 124 may send a nudge including a preview of the selected reward option and a discounted price for the item based on the selected reward option. The nudge may then be presented at to the customer via the e-commerce platform 110. For example, the nudge may be a small icon like Nudge 620, Nudge 830, or Nudge 930 (depicted in FIGS. 8 and 9). The nudge may include text indicating the reward such as “10% off”.

In some examples, the nudge may further include detail information to be presented upon expansion of the nudge. For example, the detail information may include details of the selected reward option and details of the computation of the discounted price. In some examples, such as when a cart for the current session already exists, the preview may additionally include respective discounted prices for each of the selected items in the cart. The selected items in the cart and the respective discounted prices may be included as part of the detail information of the preview, which may be viewed upon expansion of the nudge. In some examples, the detail information may include other available reward options other than the one selected, and may include interactions to allow the customer to elect one of the available reward options.

In some examples, the nudge and/or preview may include an interactive button or other interaction to allow the customer to elect to redeem the reward option. The e-commerce platform 110 and/or the loyalty reward system 120 may then receive a response to the nudge and/or preview from the customer. If the response includes an indication from the customer to apply the reward option, then the e-commerce platform may store the reward for a subsequent purchase. In response to selection of one or more items for the subsequent purchase, the reward option is applied to the selection. For example, the e-commerce platform 110 may determine whether a cart of a current session includes one or more selected items. When the cart includes one or more selected items, the platform 110 may apply the reward option to the cart (i.e., the current purchase). When there are no items in the cart, the reward option may be applied to the next items to be added to the cart which could be during the same session or a later session when the user returns to the merchant website after, for example, a few days.

Advantageously, the preview allows the user to preview potential reward options and discounts at an appropriate time to streamline communications between the loyalty rewards system 120 and the platform 110 by precomputing a reward option and generating the preview. That way, the user does not need to view the cart and rotate through the application of different reward options, creating more computational requirements at the platform 110 and/or the loyalty rewards system 120 to apply and remove the reward options.

Returning to FIG. 7A, if, at Detect 710, the user is not verified or identified then the nudge system of the Loyalty Reward System 120 provides nudges with Sign 720 which encourages the user to sign into their account or to create an account with the merchant. The encouragement from the Sign 720 include nudges with, for example, messages on how to earn rewards or reward points and the different rewards that may be available. The Sign 720 functions with Detection 710 until the Detection 710 is able to verify or identify the user.

The Loyalty Reward System 120, through its Nudge module 124, interacts with the user to further present nudges to the user while the user is shopping anywhere on a website including viewing the cart, home page, and product pages. Further, the Nudge System may also present users with action items such as click to use reward points, select what you to redeem for in a panel, click to apply reward to items in a cart, click to apply code, and click to view reward. The terms “click” and “select” are user actions and are used for clarity. They are not intended to limit the types of user interactions available with the Nudge System. The Nudge System may use any of the types of user interactions known in the art.

The user starts with a Purchase 725 of a product(s) from a merchant. From the Client 130, the user selects the product(s) to be purchased. The selected product(s) to purchase may be in what is commonly known as a shopping cart.

The Purchase 725 is submitted for Process 730 which includes, for example, the checkout (a commonly known process) process. The Process 730 further includes processing by the Platform 110 for to verify the customer ID (verification is optional), to obtain payment information and other information as is needed, and to apply any discount or promotional codes. The Platform 110 Process 730 processes the purchase. The Process 730 processing may include receiving payment information and sending a message to confirm the purchase (or event) to the user. A record of the event, this purchase, is updated for the merchant's account on the Platform 110. The step of verifying the customer ID is optional and may be skipped if the customer ID verification has sufficient accuracy such as when the user has signed into their account with the merchant in their purchase or such as when the user has provided payment information. The Process 730 further includes providing this purchase event to the Loyalty Reward System 120 so that reward points or rewards can be awarded to the user's account or the customer ID if the user is a guest user.

The customer ID may be verified to actually belong to the registered user or guest user by a number of known methods such as confirmation from an email sent to the user's email address.

Once the user clicks the purchase button or clicks the confirm the purchase under the Process 730, a Confirmation 735 of the purchase is also sent, such as by email, to the user so that they may have a written confirmation of their purchase. Where the Confirmation 735 has been sent to the guest user via a secured communications means such as via SMS to their telephone number, a URL link which to redeem any rewards earned from the purchase and may also included in the confirmation so that a guest user may accordingly redeem their reward points without becoming a registered user.

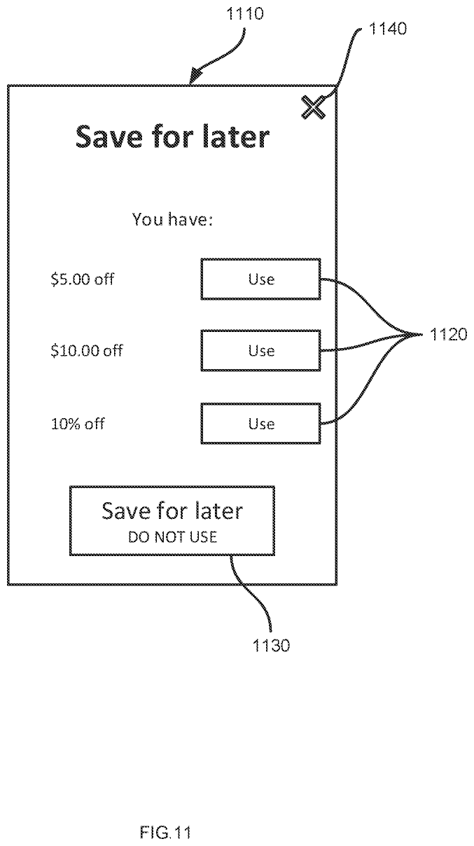

FIG. 8A shows a Page 800 of the merchant's website which shows an Item 810 in focus by a user (i.e., an item page or product page being accessed). The user has selected a “10% off” discount from a nudge displayed by Assist 715 as shown in FIG. 11 upon landing at the merchant's website. An example of the user focusing on an item may be detected by the Loyalty Rewards System 120 if the user clicks on the Item 810 (the sweater) from another page for example, and more Details 820 of the Item 810 are displayed. Further, an Add Button 825 (the “ADD TO CART” Button 825) may also be displayed. Once the Add Button 825 is clicked, the Item 810 is added to the shopping cart.

To provide more information and to encourage the user to add Item 810 to the shopping cart, a Nudge 830 is displayed with some information on the discount of “$4.00 off your order” as shown in FIG. 8A. When Nudge 830 is clicked by the user, an expansion 840 of the nudge 830 is displayed, as shown in FIG. 8B by Assist 715 showing more details of the discount the Item 810, the cost, and the net cost of the item if the “10% discount” were to be applied (i.e., the discounted price). While Nudge 830 and expansion 840 are shown together in FIG. 8B, expansion 840 may alternatively be displayed without Nudge 830 where clicking Nudge 830 then displays expansion 840 while clicking expansion 840 then minimizes the expansion 840 to display the Nudge 830.

In this example, the Add Button 825 is used and the Item 810 is added to the shopping cart.

The Nudge 830 and expansion 840 are displayed by the nudge module 124 of the Loyalty Reward System 120.

Further, FIG. 8B includes a “Earn additional discounts” Button 850 and a “Save for later” Button 860. The “Earn additional discounts” Button 850, once clicked (or selected) by the user, displays other methods for the user to earn additional rewards or reward points is shown in more detail in FIG. 10.

The “Save for later” Button 860, once clicked (or selected) by the user, displays for example a nudge as shown in FIG. 11 for the user to re-select another reward or to not use any reward. For example, if do not use a reward is selected then the Nudge System stops applying any rewards (such as for example the 10% discount of this example) to the user's purchases in Nudge 830, Nudge 930, checkout, and any other page.

FIG. 9 shows a Page 900 of the merchant's website which shows Another Item 910 in focus by a user with Item 810 having been added to the user's shopping cart. The user is focusing on an item, as detected by the Loyalty Rewards System 120, as the user has clicked on the Item 910 (the Skirt) from another page for example, and more Details 920 of the Item 910 are displayed. Further, an Add Button 925 (the “ADD TO CART” Button 925) may also be displayed. Once the Add Button 925 is clicked, the Item 910 is added to the shopping cart.

To provide more information and to encourage the user to add Item 910 to the shopping cart, a Nudge 930 is displayed with some information on the discount of “$7.00 off your order”. When Nudge 930 is clicked by the user, an expansion 940 is displayed by Assist 715 showing more details of the discount which has the Item 910, the Item 810, the cost of each item, and the net cost of the items if the “10% discount” were to be applied (i.e., the respective discounted prices of each item in the cart). The net cost here includes the items in the shopping cart to provide the user a cost of the items while continuing to shop without having to go to the shopping cart page or to the checkout page of the website.

While Nudge 930 and expansion 940 are shown together in FIG. 9, only Nudge 930 is initially shown when the user is initially focused on the Item 910. When Nudge 930 is clicked, the more detailed information in expansion 940 is displayed.

Alternatively, only one of Nudge 930 and expansion 940 is shown at any one time, by clicking Nudges 930 then expansion 940 is displayed without Nudge 930, and by clicking expansion 940 then displays Nudge 930 instead.

Further, similar to FIG. 8, FIG. 9 also include a “Earn additional discounts” Button 950 and a “Save for later” Button 960 with the same functions of Button 850 and Button 860.

FIG. 10 shows a part of a Page 1000 of the merchant's website which shows the Item 810 in focus by a user where clicking or selecting the “Earn additional discounts” Button 850 displays a “Earn additional discounts” Nudge 1010. In some examples, the nudge 1010 may be an expansion. The nudge 1010 may also be presented, for example upon performance of the method 740 to encourage users to earn other discounts and/or rewards points to achieve a reward level. The Nudge 1010 displays information about how to earn rewards or rewards points which could include “Refer a friend Get $5 off for each friend” with a code that can be Copied 1030 for the user to provide to their friends, “Follow on social media Get $2 off for each fellow” with Icons 1020 for the user to click to access the particular social media directly from within Nudge 1010, and “Place two orders within a month Get $10 off”. Further, Nudge 1010 provides another method to earn rewards or reward points by playing a game “Hide and Seek”, and “Play a hide and seek game to unlock other discounts” with a Play Button 1040.

Similarly, the “Earn additional discounts” Nudge 1010 Nudge is displayed when “Earn additional discounts” Button, wherever it may be shown, is clicked or selected on Page 900 and other pages of the merchant's website.

While Nudge 1010 has the user playing a game to earn rewards or reward points for the user; to earn rewards or reward points, other implementations may have, for example, the user watching a video, answering a survey, viewing advertisements, and other paid activities where the other parties are interested in paying for having the user's attention for their products and/or services. This method of earning reward points can be advantageous when the user just needs a few reward points to earn a new reward. For example, when the other non-purchasing methods (such as “fellow on social networks”) to earn points are exhausted, a user may still watch a few advertisement videos to earn more points as there are numerous advertisement videos available from advertisers.

FIG. 11 shows a “Save for later” Nudge 1110 which would be displayed on a page of the merchant's website when a “Save for later” Button (as shown in FIGS. 8 and 9) is clicked or selected by the user. The “Save for later” Nudge 1110″ is displayed on the same page as the clicked or selected “Save for later” Button such as “Save for later” Button 860 and “Save for later” Button 960.

The “Save for later” Nudge 1110 provides three (3) rewards in which one or any combination of the rewards may be selected to be used. The examples herein have been shown with one reward being applied to the items being purchased for simplicity of illustration. More than one reward may be applied to the items in one purchase. Such reward rules limiting the rewards that may be applied to one purchase may be set by the particular merchant.

This Nudge 1110 is a user interaction nudge where there is a rewards type message of “Save for later ‘$5 off’ ‘$10 off’ ‘10% off’” with a user interaction 1120 “USE” button beside each reward ‘$5 off’, ‘$10 off’, or ‘10% off’. A user may click one or more of the user interaction 1120 “USE” buttons to select the reward beside each of the buttons. This action may result in the reward being applied to the purchase to be re-selected, for example, from “10% off” to “$10 off”. To not use any rewards with the current purchases in the shopping cart, there is a “Save for later Do Not Use” Button 1130. The Nudge 1110 is closed once the “Save for later Do Not Use” Button 1130 is clicked or selected, or the Close Button 1140 is clicked or selected.

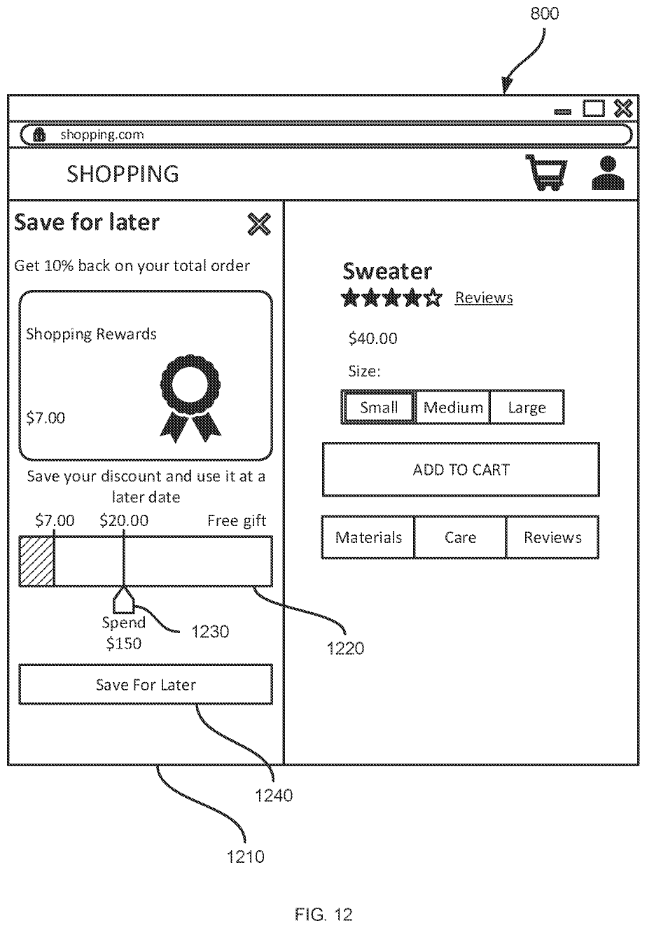

FIG. 12 shows a “Save for later” Nudge 1210 according to an alternate implementation. The “Save for later” Nudge 1210 is shown as part of a Page 800 of the merchant's website which shows THE Item 810 in focus by a user where the user has clicked or selected the “Save for later” Button 860 accordingly to FIG. 8. The “Save for later” Nudge 1210 shows “Save for later Get 10% back on your total order” (the 10% being the reward currently being applied), “$7.00” being the amount saved by the 10% off reward. Further, a Bar 1220 has $7.00, $20.00, and Free Gift as rewards depending on the amount of money spent on their purchase. As shown, the Bar 1220 has a darker part indicating the amount being spent to earn the $6.70 reward. In conjunction with Bar 1220, a Pointer 1230 is moveable along the Bar 1220. The Pointer 1230 is currently shown as a $20.00 reward for “Spend $150.00”. By using this method, it is possible to have rewards based on non-linear amounts spent. As shown, the $20.00 reward for “Spend $150” has a 13.33% off discount at the amount spent of $150. Further, the “Save for later” button 1240 may be clicked or selected to not use any rewards with the current purchases in the shopping cart.

It is to be understood that this invention is not limited to the specific devices, methods, conditions, or parameters described and/or shown herein, and that the terminology used herein is for the purpose of describing particular embodiments by way of example only. Thus, the terminology is intended to be broadly construed and is not intended to be limiting of the claimed invention. For example, as used in the specification including the appended claims, the singular forms “a,” “an,” and “one” include the plural, the term “or” means “and/or,” and reference to a particular numerical value includes at least that particular value, unless the context clearly dictates otherwise. In addition, any methods described herein are not intended to be limited to the sequence of steps described but can be carried out in other sequences, unless expressly stated otherwise herein.

The scope of the claims should not be limited by the embodiments set forth in the above examples but should be given the broadest interpretation consistent with the description as a whole.

1. An e-commerce system comprising:
an e-commerce platform to:
identify a customer identifier associated with a customer browsing a vendor e-storefront on the e-commerce platform; and
a loyalty rewards system in communication with the e-commerce platform, the loyalty rewards system to:
receive the customer identifier from the e-commerce platform;
identify a point balance associated with the customer identifier for the customer;
determine whether the point balance satisfies a threshold condition;
when the point balance satisfies the threshold condition, select a reward option; and
send, from a nudge module of the loyalty rewards system, a nudge including the selected reward option for presentation by the e-commerce platform to the customer; and
wherein the e-commerce platform is further to:
in response to an indication from the customer to apply the reward option, store the reward option for a subsequent purchase; and
in response to a selection of one or more items for the subsequent purchase, apply the reward option to the selection.

2. The e-commerce system of claim 1, wherein the e-commerce platform is further to:
detect a predictor of a purchase by the customer; and
send the customer identifier to the loyalty rewards system in response to detecting the predictor.

3. The e-commerce system of claim 1, wherein the threshold condition comprises a threshold point balance.

4. The e-commerce system of claim 1, wherein the reward option comprises one or more of: a discount percentage and a discount amount.

5. The e-commerce system of claim 1, wherein the loyalty rewards system is to select the reward option based on one of: a largest available reward option, a smallest available reward option, or a randomly-selected available reward option.

6. The e-commerce system of claim 1, wherein, in response to the indication to apply the reward option, the loyalty reward system is to update the point balance associated with the customer identifier.

7. The e-commerce system of claim 1, wherein the e-commerce platform is to:
determine whether a cart of a current session includes one or more selected items; and
when the cart includes one or more selected items, apply the reward option to the cart as the selection.

8. The e-commerce system of claim 1, wherein the nudge further comprises detail information to be presented by the e-commerce platform upon expansion of the nudge.

9. The e-commerce system of claim 1, wherein the loyalty rewards system is to select a plurality of available reward options to be included in the nudge for selection of a designated reward option of the plurality of available reward options; and
wherein the e-commerce system is to use the selection of the designated reward option as the indication to apply the designated reward option.

10. A method comprising:
identifying a customer identifier associated with a customer browsing a merchant e-storefront serviced by an e-commerce platform;
identifying a point balance associated with the customer identifier;
determining whether the point balance satisfies a threshold condition;
when the point balance satisfies the threshold condition, selecting a reward option;
sending a nudge including the selected reward option for presentation by the e-commerce platform to the customer;
in response to an indication from the customer to apply the reward option, storing the reward option for a subsequent purchase; and
in response to a selection of one or more items for the subsequent purchase, applying the reward option to the selection.

11. The method of claim 10, further comprising:
detecting a predictor of a purchase by the customer; and
sending the customer identifier to the loyalty rewards system in response to detecting the predictor.

12. The method of claim 10, wherein the threshold condition comprises a threshold point balance.

13. The method of claim 10, wherein the reward option comprises one or more of: a discount percentage and a discount amount.

14. The method of claim 10, wherein selecting the reward option is based on one of: a largest available reward option, a smallest available reward option, or a randomly-selected available reward option.

15. The method of claim 10, further comprising, in response to the indication to apply the reward option, updating the point balance associated with the customer identifier.

16. The method of claim 10, further comprising:
determining whether a cart of a current session includes one or more selected items; and
when the cart includes one or more selected items, applying the reward option to the cart as the selection.

17. The method of claim 10, wherein the nudge further comprises detail information to be presented by the e-commerce platform upon expansion of the nudge.

18. The method of claim 10, further comprising selecting a plurality of available reward options to be included in the nudge for selection of a designated reward option of the plurality of available reward options; and
using the selection of the designated reward option as the indication to apply the designated reward option.
